(19) United States
(12) Patent Application Publication
(10) Pub. No.: US 2003/0035296 A1
(43) Pub. Date: Feb. 20, 2003

(54) Vehicle lamp

(75) Inventors: Kazunori Natsume, Shizuoka (JP); Masao Matsubara, Shizuoka (JP)

Correspondence Address: Koda & Androlia, 2029 Centsury Park East, Suite 3850, Los Angeles, CA, 90067, US

(73) Assignee: Koito Manufacturing Co., Ltd.

(21) Appl. No.: 10/215,788

(22) Filed: Aug. 9, 2002

(30) Foreign Application Priority Data
Aug. 17, 2001 (JP) P.2001-247617

(51) Int. Cl. B60Q 1/00

(52) U.S. Cl. 362/487

(57) ABSTRACT

A vehicle lamp of which lamp chamber is formed by a lamp body and an outer lens, and a light source and an inner lens are provided inside the lamp chamber, with the inner lens functioning to selectively transmit the complementary color to the color of the outer lens and a desired color and being disposed between the light source and the outer lens. A half mirror is provided on the inner lens so as to face the outer lens.

### BACKGROUND OF THE INVENTION

1. Field of the Invention

The present invention relates to a vehicle lamp (hereinafter referred to as “lamp”) that changes the color between when it is lit and when it is unlit.

2. Prior Art

A turn signal lamp of a vehicle, for instance, is generally designed so that it changes its color between when they are lit and when they are not lit. The color is changed so that the color aesthetically matches with colors of other adjacent lamps and a body panel when it is not lit but becomes, when it is lit, a predetermined functional color specified by laws and regulations.

One example of such a lamp is shown in FIG. 8.

The lamp 10 of FIG. 8 is comprised of a lamp body 14 and an outer lens 12. The lamp body 14 is integrally formed with a reflector 13 that has a parabolically shaped surface. The outer lens 12 is formed with steps 19 on an inner surface thereof. The steps 19 make a light distribution control. The lamp body 14 and outer lens 12 forms a lamp chamber; and in this lamp chamber defined by the lamp body 14 and outer lens 12 is provided with a white light source 16. The lamp 10 further includes an inner lens 18 which is an optical filter member and is interposed between the light source 16 and the outer lens 12.

The outer lens 12 is colored in smoke pink so as to offer a sense of harmony with adjacent other lamps, such as a red tail lamp and a stop lamp. The inner lens 18 has a yellowish-green color so as to selectively transmit the light of an amber color emitted when the lamp 10 is lit and the light of complementary color to the color (pink smoke) of the outer lens 12.

When the lamp 10 is not lit, the external light 22 is reflected by the outer lens 12 which is colored in pink smoke; and thus the lamp 10 appears reddish and offers a sense of harmony with other red lamps. However, when the lamp 10 is lit, the light of the amber color and the light of complementary color to pink smoke are selected from the lights 23 irradiated from the light source 16. As a result, the light of amber color and the light of complementary color to pink smoke are transmitted through the outer lens 12. The light of complementary color to pink smoke is mixed with the light of the pink smoke color of the outer lens 12 and becomes a colorless white light when it passes through the outer lens 12, while the light of the amber color is directly emitted outside from the outer lens 12. As a result, the lamp 10 appears amber when the lamp is lit.

As seen from the above, if the optical filter member, such as the inner lens 18, is colored so that it can selectively transmit the light of a desired color (which is amber color in the above prior art) to be emitted from the lamp 10 and the light of complementary color to the color of the outer lens 12, then the lamp appears in the color of the outer lens 12 when it is not lit and appears in the color emitted or in the desired color when it is lit.

In the above-described lamp 10, when the lamp is not lit, a considerable portion of the external light 22 is reflected by the outer lens 12. However, as seen from FIG. 9, a part of the external light 22 passes through the outer lens 12 and the inner lens 18 and is reflected by the reflector 13. Resultantly, the external light entered into the lamp 10 becomes a reflector reflected light 25; and this reflector reflected light 25 passes through the inner lens 18 and the outer lens 12 and emitted out of the lamp 10.

The light of complementary color to the color of the outer lens 12 and the light of amber color in this reflector reflected light 25 are, as described above, separated by the inner lens 18. When passing through the outer lens 12, the light of complementary color to the color of the outer lens 12 is mixed with the color of the outer lens 12 and becomes a colorless white color light. Thus, it does not affect the color of the lamp 10. However, the light of amber color elected by the inner lens 18 passes through the outer lens 12 and is emitted out of the lamp 10 directly. As a result, even when the lamp 10 is not lit, the light of the amber color makes the lamp 10 appear somewhat amber, causing the problem that a difference in color of the lamp between when the lamp is lit and it is not lit is not conspicuous.

One solution of the above problem is a use of a small cap 55 instead of the inner lens 18 as shown in FIG. 10. In this structure, the cap 55 that covers the light source 16 is used as an optical filter member. With this cap 55, when the external light 22 entered into the lamp 10 is reflected by the reflector 13 and such a reflector reflected light 25 travels to the outside, the cap 55 minimizes the external light 22 and the reflector reflected light 25 that pass through the cap 55 as much as possible. As a result, the lamp 10 is prevented from appearing in amber color that is selected by the cap 55.

However, because of the size of the cap 55, a part of the external light 22 and the reflector reflected light 25 still pass through the cap 55. Thus, the lamp 10 cannot be sufficiently prevented from appearing amber when it is not lit.

### SUMMARY OF THE INVENTION

Accordingly, the object of the present invention to provide a vehicle lamp that assuredly shows the color of its outer lens when it is not lit, so that the difference in color of the lamp between when the lamp is lit and when it is not lit is conspicuous.

The above object is accomplished by a unique structure of the present invention for a vehicle lamp that is comprised of a lamp body and an outer lens which define a lamp chamber with a light source and an optical filter member provided therein, the optical filter member selectively transmitting the light of complementary color to the outer lens color and the light of a desired color and being disposed between the light source and the outer lens; and in the present invention, a half mirror is provided so that it is disposed on an outer lens side of the optical filter member.

With the above structure, even if the external light passes through the outer lens when the lamp is not lit, the external light passed through the outer lens is reflected by the half mirror and travels through the outer lens, thus being emitted back to the outside. Accordingly, the color of the outer lens is enhanced. Moreover, the half mirror prevents, as much as possible, that the external light passes through the half mirror and optical filter member and is reflected by the reflector and then emitted out to the outside. Thus, when the lamp is not lit, the lamp is prevented from appearing in a desired color that is selected by the optical filter member, and it shows the color of its outer lens. As a result, the difference in color between when the lamp is lit and when it is not lit becomes conspicuous.

Furthermore, in the present invention, a plain lens can be used for the outer lens, and the optical filter member can be formed with steps on the surface on which the half mirror is not provided. The “plain” is meant to allow the inside of the lamp body to be visible substantially transparently from the outside; and thus a plain outer lens is a lens that is not formed with diffusion steps for light distribution control; and if such steps are formed, each step has a large radius of curvature. Because of the plain outer lens, the steps (diffusion steps) of the optical filter member are visible from the outside only when the lamp is lit and not visible because of the half mirror when the lamp is not lit. This gives even a greater change to the appearance of the lamp, though the change in the color is the same between when the lamp is lit and when it is not lit.

Furthermore in the present invention, a plain outer lens and a plain optical filter member (that has the half mirror on its one side) can be used along with a reflector that has steps thereon and is provided on the inner surface of the lamp body. In this structure, the steps on the reflector are visible from the outside only when the lamp is lit and are not visible because of the half mirror when the lamp is not lit. This structure gives even a greater change to the appearance of the lamp, though the change in the color is the same between when the lamp is lit and when it is not lit.

Further, in the present invention, the optical filter member can be a small cap that covers the light source. In this structure, when the external light enters the inside of the lamp and is reflected by the reflector so as to travel back to the outside, the external light is prevented from passing through the optical filter member as much as possible. As a result, the lamp is prevented from appearing in a desired color selected by the optical filter member, thus ensuring that the lamp appears in the color of the outer lens.

The above object is accomplished by another unique structure of the present invention for a vehicle lamp that is comprised of a lamp body and an outer lens which define a lamp chamber with a light source and an optical filter member provided therein, the optical filter member selectively transmitting the light of complementary color to the outer lens color and the light of a desired color and being disposed between the light source and the outer lens; and in the present invention, a half mirror is provided so that it is disposed on an optical filter member side of the outer lens.

In this lamp structure, even if an external light passes through the outer lens when the lamp is not lit, the external light is reflected by the half mirror provided on the inner surface of the outer lens and passes through the outer lens so as to be emitted to the outside. Accordingly, the color of the outer lens is enhanced. Moreover, the half mirror prevents, as much as possible, that the external light passes through the half mirror and the optical filter member and is reflected by the reflector and then emitted out to the outside. Thus, the lamp is prevented from appearing in the desired color that is selected by the optical filter member and shows the color of its outer lens when the lamp is not lit. As a result, the difference in color between when the lamp is lit and when it is not lit becomes even more conspicuous.

### BRIEF DESCRIPTION OF THE DRAWINGS

FIG. 1 shows a lamp in cross section according to the first embodiment of the present invention;

FIG. 2 shows the light path of an external light entering the inside of the lamp of the first embodiment;

FIG. 3 shows a lamp in cross section according to the second embodiment of the present invention;

FIG. 4 shows a lamp in cross section according to the third embodiment of the present invention;

FIG. 5 shows a lamp in cross section according to the fourth embodiment of the present invention;

FIG. 6 shows a lamp in cross section according to the fifth embodiment of the present invention;

FIG. 7 shows a lamp in cross section according to the sixth embodiment of the present invention;

FIG. 8 shows a conventional lamp in cross section;

FIG. 9 shows the light path of an external light entering the inside of the conventional lamp; and

FIG. 10 shows another conventional lamp in cross sectional.

### DETAILED DESCRIPTION OF THE INVENTION

Preferred embodiments of the present invention will be described below in detail with reference to the accompanying drawings.

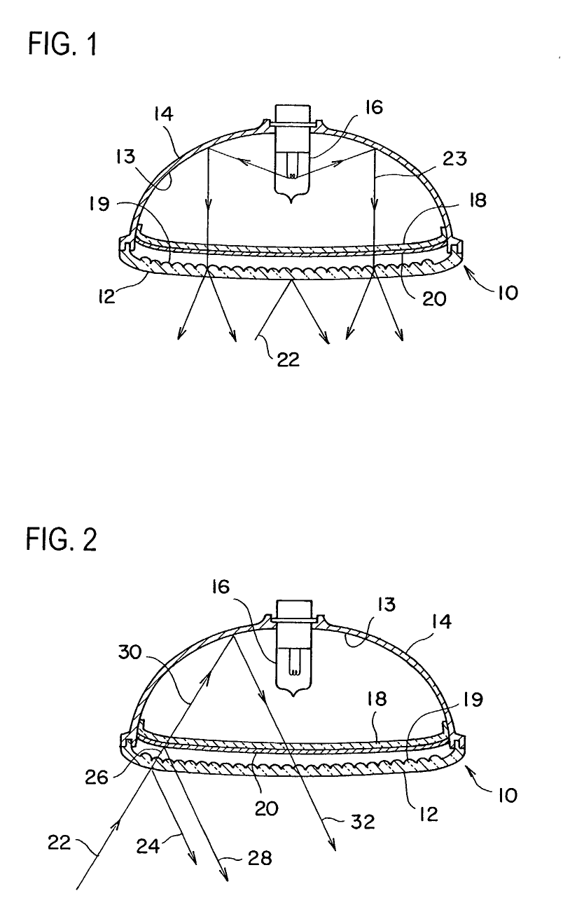

The lamp 10 of the first embodiment of the present invention shown in FIG. 1 has a similar structure as the conventional lamp shown in FIG. 8.

More specifically, the lamp chamber is defined by an outer lens 12 colored in pink smoke and a lamp body 14 integrally formed with a reflector 13 that has a parabolically shaped surface. A white light source 16 is disposed inside the lamp chamber, and an inner lens 18 colored in yellowish-green as an optical filter member is interposed between the light source 16 and the outer lens 12. Diffusion steps 19 for light distribution control, such as fisheye steps, are formed on the backside (inner) surface of the outer lens 12. The lamp 10 of FIG. 1 differs from the conventional lamp in that the inner lens 18 is provided with a half mirror 20 on an outer lens 12 side (surface) thereof. In other words, the half mirror 20 is disposed on the surface of the inner lens 18 that faces the outer lens 12.

The half mirror 20 is a vapor deposited thin metal film, and it reflects about half of an incident light, while allowing about the remaining half to pass therethrough. It is desirable that the transmittance of the half mirror 20 be set to 30 to 70%, more preferably to 35 to 45%. If the transmittance is higher than these ranges, the same condition as that which has no half mirror 20 provided thereon is established, causing the lamp 10 to appear amber (due to the external light) when it is not lit. On the other hand, if the transmittance is lower than the above ranges, it becomes more difficult for the light from the light source 16 to be emitted to the outside of the lamp 10, resulting in insufficient luminance when the lamp is lit.

With the structure described above, as in the conventional lamp, the light 23 emitted from the light source 16 when the lamp 10 is lit is reflected by the reflector 13, passes through the inner lens 18, the half mirror 20 and the outer lens 12 and emits an amber colored light to the outside of the lamp 10.

When the lamp 10 is not lit, as seen from FIG. 2, a considerable part of the external light 22 is reflected by the outer lens 12. This outer lens reflected light 24 is composed mainly of a pink smoke color component. About a half of the light 26 that passes through the outer lens 12 is reflected by the half mirror 20 and travels through the outer lens 12 to the outside. This half mirror reflected light 28 is also composed mainly of a pink smoke color component. As a result, compared to the conventional lamp, the color (pink smoke color) of the outer lens 12 of the embodiment of FIG. 1, is enhanced even more compared to the conventional lamp when the lamp 10 is not lit.

Furthermore, about a half of the light 26 that has passed through the outer lens 12 passes through the half mirror 20 and, when passing through the inner lens 18, becomes the light 30 that is comprised of a light of complementary color to the color of the outer lens 12 and a light of the amber color. The light 30 is reflected by the reflector 13 and becomes a reflector reflected light 32. When traveling through the inner lens 18 and the half mirror 20, the reflector reflected light 32 is dimmed to about a half. When the reflector reflected light 32 is emitted to the outside through the outer lens 12, the light of complementary color to the color of the outer lens 12 becomes a white light, while the light of the amber color is emitted directly as is. However, the light of the amber color included in the reflector reflected light 32 emitted outside becomes extremely weaker than the light of the color of the outer lens 12 included in the outer lens reflected light 24 and the half mirror reflected light 28. Therefore, the lamp 10 is prevented from appearing amber when the lamp is not lit, and lamp 10 shows the color of the outer lens 12 when the lamp 10 is not lit. Thus, the lamp 10 shows a significant difference in color between when the lamp 10 is lit and when it is not lit.

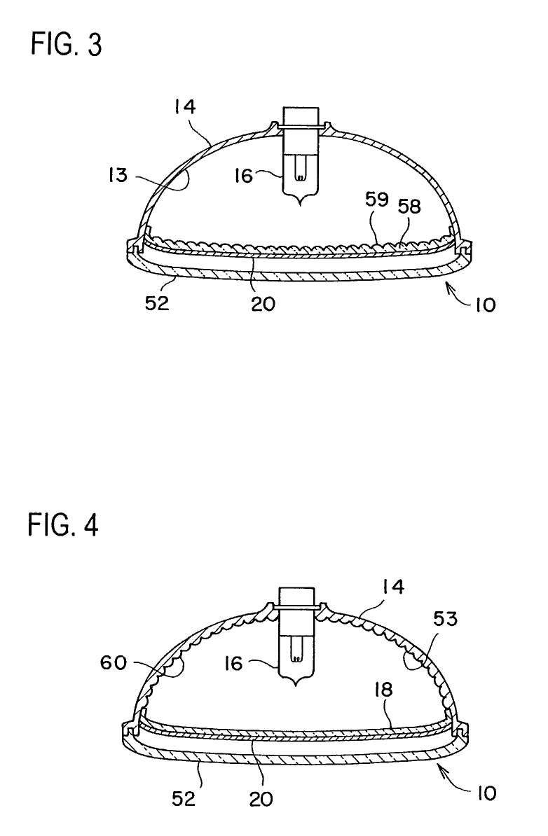

FIG. 3 shows the lamp 10 of the second embodiment of the present invention.

The lamp 10 shown in FIG. 3 is the same as the lamp of the first embodiment except that its outer lens 52 is “plain,” and its inner lens 58 is formed with light diffusion steps 59 on the surface on which the half mirror 20 is not provided. In other words, the inner lens 58 is formed with diffusion steps 58 so that it is disposed on the surface opposite from the surface on which the half mirror 20 is provided. The above-described “plain” is meant to allow the inside of the lamp body to be seen substantially transparently from the outside; and thus the plain outer lens 52 is not formed with diffusion steps for light distribution control; and even if such steps are formed, each step has a large radius of curvature.

In the first embodiment, the parting lines of the steps 19 of the outer lens 12 are visible at all times from the outside of the lamp 10 to a greater or lesser extent between when the lamp 10 is lit and when it is not lit. However, in the lamp 10 of the second embodiment of FIG. 3, the steps 59 are formed on the inner lens 58, and such steps 59 of the inner lens 58 are visible only when the lamp 10 is lit; and when the lamp is not lit, the steps 59 are not visible because of the half mirror 20. Accordingly, the outer lens 52 of the lamp 10 of FIG. 3 appears more clear-cut, thus giving an even greater change in appearance of the lamp 10 between when the lamp is lit and when it is not lit.

FIG. 4 shows the third embodiment of the present invention.

The lamp 10 of the third embodiment is the same as the lamp of the second embodiment except that both the outer lens 52 and the inner lens 18 are plain and thus not formed with diffusion step, but the lamp body 14 is formed on its front surface with diffusion steps 60 for light distribution control, thus forming a stepped reflector 53.

As in the lamp of the second embodiment, the steps 60 of the reflector 53 are visible only when the lamp is lit, while the steps 60 are not visible because of the half mirror 20 when the lamp is not lit. This makes the outer lens 52 of the lamp 10 appear more clear-cut, thus giving an even greater change in appearance of the lamp 10 between when the lamp is lit and when it is not lit.

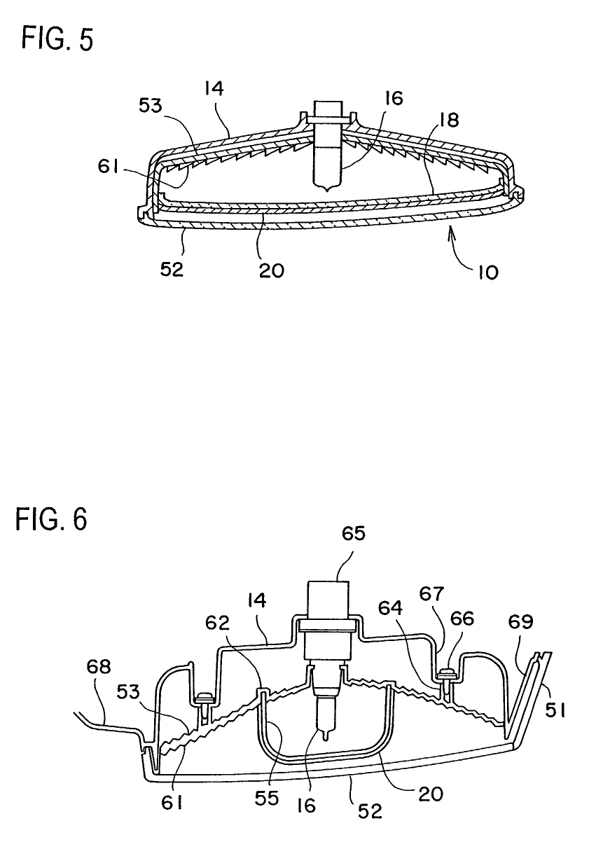

FIG. 5 shows the fourth embodiment of the present invention.

The lamp 10 of the fourth embodiment is the same as that of the third embodiment of FIG. 4 except that a reflector 53 that has diffusion steps 61 is provided. The diffusion steps 61 of the reflector 53 are stair-like diffusion steps and concentrically formed on the front surface of the lamp body 14 so as to reflect the light emitted from the light source 16 in a diffused manner in a predetermined direction.

As in the lamp of the third embodiment, the steps 61 on the reflector 53 are visible only when the lamp is lit, while the steps 61 are not visible because of the half mirror 20 when the lamp is not lit. This makes the front surface of the lamp 10 appear more clear-cut, thus giving an even greater change in appearance of the lamp 10 between when the lamp is lit and when it is not lit. In addition, because of the stair-like diffusion steps 61, the reflector 53 can be made shallower in depth, thus making the entire lamp 10 more compact.

FIG. 6 shows the fifth embodiment of the present invention; and in this fifth embodiment, a small cap 55 is employed.

More specifically, in the fifth embodiment, in place of the inner lens used in the previous embodiments, the cap 55 is installed so as to cover the light source 16. The cap 50 is provided with a half mirror 20 on the side that faces the outer lens 52 so as to work as an optical filter member. A cap mounting portion 62, which includes a groove of a concentric shape with the light source 16, is formed in the reflector 53; and the periphery of the cap 55 is fitted in this groove. The cap 55 is fastened in place in the cap mounting portion 62 by appropriate means and thus connected to the reflector 53. Except this arrangement of the cap 55, the fifth embodiment is substantially the same as the fourth embodiment shown in FIG. 5.

In the fifth embodiment, when the external light (not shown in FIG. 6) enters the inside of the lamp 10 and reflected by the reflector 53 so as to travel back to the outside, it is possible to minimize the external light passing the cap 55 as much as possible, thereby even more reliably preventing the lamp 10 from appearing in amber color selected by the cap 55. Furthermore, since the external light is more likely to be reflected by the reflector 53 and emitted out of the lamp 10, the steps 61 of the reflector 53 are visible at all times from the outside of the lamp 10 to a greater or lesser extent between when the lamp is lit and when it is not lit.

A further detailed description will be made below with reference to the fifth embodiment shown in FIG. 6.

The reflector 53 is provided with lamp body mounting portions 64 having threaded holes therein, and recessed portions 67 having screw insertion holes are also provided in the lamp body 14 so as to positionally correspond to the lamp body mounting portions 64. The reflector 53 is connected to the lamp body 14 by screws 66 screwed into the threaded holes in the lamp body mounting portions 64. In addition, a socket 65 is mounted at a central portion of the lamp body 14 and the reflector 53, and the light source 16 is installed in the stock 65. A first extended portion 51 is formed in the outer lens 52 so that the outer surface of the outer lens can be continuous to the body panel of a vehicle. Likewise, a second extended portion 68 is formed in the lamp body 14 so that the outer surface of the lamp body 14 can be continuous to the body panel; and a third extended portion 69 is formed in the lamp body 14 so that the third extended portion 69 is connected to the extended portion 51 of the outer lens 52.

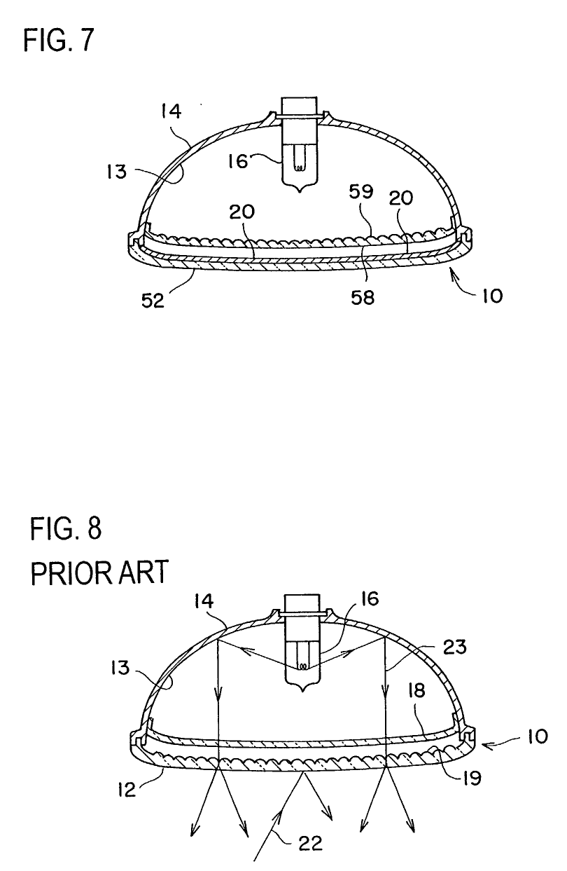

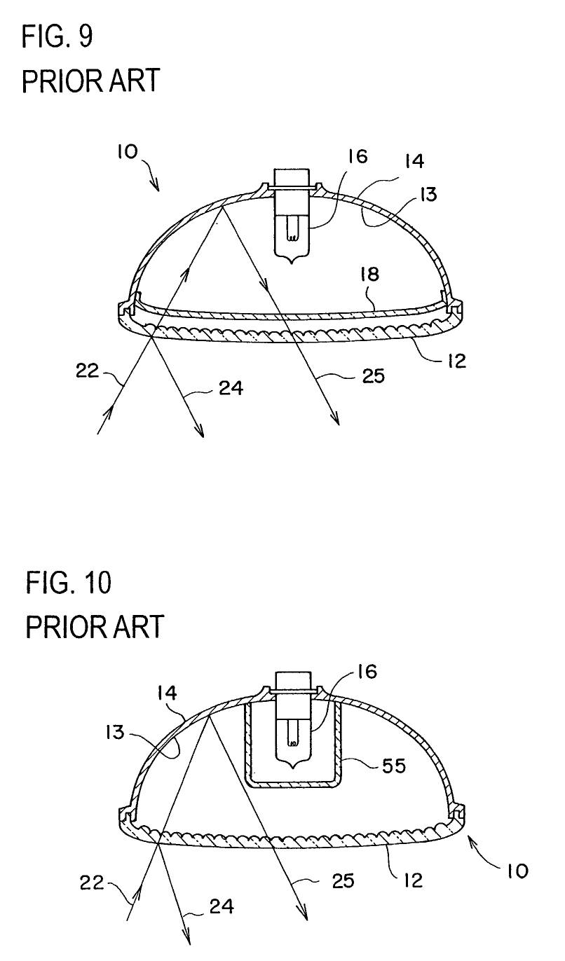

FIG. 7 shows the sixth embodiment of the lamp of the present invention.

The lamp 10 in FIG. 7 is the same as the lamp of the second embodiment shown in FIG. 3 except that the inner lens 58 is not provided with a half mirror. Instead, a half mirror 20 is provided on the inner surface of the outer lens 52. In other words, the half mirror 20 is provided on the outer lens 52 so as to face the inner lens 58 that is formed with diffusion steps 59 on the inside surface.

In this structure of the sixth embodiment, even if the external light (not shown) passes through the outer lens 52 when the lamp 10 is not lit, it is reflected by the half mirror 20 provided on the inner surface of the outer lens 52 and emitted out of the lamp 10, which helps enhance the color (pink smoke color) of the outer lens 52. Moreover, the half mirror 20 prevents as much as possible the external light from passing through the half mirror 20 and the inner lens 58 and from being reflected by the reflector 13 so as to be emitted to the outside. This eliminates the possibility of the lamp 10 appearing in the desired color (amber color) selected by the inner lens 58 and ensures without fail that the lamp 10 appears in the color of the outer lens 52 when the lamp is not lit. As a result, the difference in color of the lamp 10 between when the lamp 10 is lit and when it is not lit becomes even more conspicuous. Furthermore, since the steps 59 on the inner lens 58 are visible only when the lamp is lit and are not visible because of the half mirror 20 when the lamp is not lit, the front surface of the lamp 10 appears more clear-cut, thus giving an even greater change in appearance of the lamp 10 between when the lamp is lit and when it is not lit.

It should be understood that the present invention is not limited to the embodiments described above and various modifications can still be made. For example, a color sheet or the like placed along the backside of the outer lenses 12 and 52 may be used as the optical filter member regardless of shape, material, and the like thereof, in place of the inner lenses 18 and 58 and the cap 55, as long as it selectively transmits a desired color to be emitted when the lamp is lit and the complementary color to the color of the outer lens 12.

As is clear from the foregoing description, since the lamp according to the present invention is provided with a half mirror on the outer lens side of an optical filter member, the external light, even when it passes through the outer lens to advance into the inside of the lamp, is reflected by the half mirror and travels back to the outside of the lamp, through the outer lens, when the lamp is not lit. Accordingly, the color of the outer lens is enhanced greatly; moreover, the half mirror prevents as much as possible the external light, which passes through the half mirror and the optical filter member and is reflected by the reflector, from traveling to the outside of the lamp body. Thus, the lamp does not appear in a desired color (such as amber color) selected by the optical filter member, and the lamp appears in the color of the outer lens. As a result, the difference in color between when the lamp is lit and when it is not lit becomes even more conspicuous.

Furthermore, according to the present invention, the outer lens has no diffusion steps thereon, and the diffusion steps are formed on the surface of the optical filter member on which the half mirror is not provided. The steps on the optical filter member are thus visible only when the lamp is lit and not visible when the lamp is not lit, which gives even a greater change to the appearance of the lamp between when the lamp is lit and when it is not lit.

In the present invention, further, the outer lens and the optical filter member are not formed thereon with diffusion steps, and the reflector formed thereon with steps is provided on the front surface of the lamp body. In this structure, the steps of the reflector are visible only when the lamp is lit and are not visible when the lamp is not lit. Thus, even a greater change is given to the appearance of the lamp between when the lamp is lit and when it is not lit.

Furthermore, in the present invention, the optical filter member in the form of a small cap is provided in the lamp body so as to cover the light source. Therefore, when the external light enters the inside of the lamp, is reflected by the reflector, and travels back to the outside, the external light is prevented from passing through the cap as much as possible; and as a result, the lamp is prevented from appearing in the desired color, which is selected by the cap, even more reliably.

In addition, in the present invention, a half mirror is provided on the outer lens so that the half mirror is disposed on the optical filter member side of the outer lens. In this structure, even if the external light passes through the outer lens when the lamp is not lit, the external light is reflected by the half mirror provided on the inner surface of the outer lens and emitted to the outside. Accordingly, the color of the outer lens is enhanced greatly. Moreover, the half mirror prevents as much as possible the external light, which passes through the half mirror and the optical filter member and is reflected by the reflector, from traveling back to the outside. Thus, the lamp does not appear in the desired color selected by the optical filter member, and it is ensured that the lamp appear in the color of the outer lens. As a result, the difference in color of the lamp between when the lamp is lit and when it is not lit becomes greatly conspicuous.

1. A vehicle lamp comprised of a lamp body and an outer lens which define a lamp chamber provided therein with a light source and an optical filter member, said optical filter member selectively transmitting a light of complementary color to a color of said outer lens and a light of a desired color and being disposed between said light source and said outer lens, wherein
said vehicle lamp is further comprised of a half mirror provided on an outer lens side of said optical filter member.

2. The vehicle lamp according to claim 1, wherein said outer lens is plain, and said optical filter member is provided with steps formed on a surface thereof which is opposite from a surface on which said half mirror is provided.

3. The vehicle lamp according to claim 1, wherein said outer lens and said optical filter member are plain, and a reflector formed with steps thereon is provided on an inner surface of said lamp body.

4. The vehicle lamp according to claim 1, wherein said optical filter member is a cap that covers said light source.

5. The vehicle lamp according to claim 2, wherein said optical filter member is a cap that covers said light source.

6. The vehicle lamp according to claim 3, wherein said optical filter member is a cap that covers said light source.

7. A vehicle lamp comprised of a lamp body and an outer lens which define a lamp chamber provided therein with a light source and an optical filter member, said optical filter member selectively transmitting a light of complementary color to a color of said outer lens and a light of a desired color and being disposed between said light source and said outer lens, wherein
said vehicle lamp is further comprised of a half mirror provided on an optical filter member side of said outer lens.
